(19) United States
(12) Patent Application Publication
(10) Pub. No.: US 2025/0217038 A1
(43) Pub. Date: Jul. 3, 2025

(54) METHOD OF OPERATING STORAGE DEVICE USING DYNAMIC READ SCHEME AND STORAGE DEVICE PERFORMING THE SAME

(71) Applicant: SAMSUNG ELECTRONICS CO., LTD., Suwon-si (KR)

(72) Inventors: Hojun Jo, Suwon-si (KR); Hyeonwu Kim, Suwon-si (KR); Yoonjin Lee, Suwon-si (KR)

(21) Appl. No.: 18/749,105

(22) Filed: Jun. 20, 2024

(30) Foreign Application Priority Data
Dec. 28, 2023 (KR) 10-2023-0193916

(51) Int. Cl. G06F 3/06

(52) U.S. Cl. CPC G06F 3/0611; G06F 3/0659; G06F 3/0679

(57) ABSTRACT

In a method of operating a storage device, a first command set corresponding to a first read scheme is transmitted to a nonvolatile memory based on whether a data read request has a first attribute. A second command set corresponding to a second read scheme is transmitted to the nonvolatile memory based on whether the data read request has a second attribute. The first and second command sets include a data read command and a first number of status check commands or a data read command and a second number of status check commands, respectively. The data read command is received from the nonvolatile memory. When an attribute of the data read request is changed, transmission of the the first command set to the nonvolatile memory or the second command set to the nonvolatile memory is dynamically changed.

### CROSS-REFERENCE TO RELATED APPLICATION

This application claims priority under 35 USC § 119 to Korean Patent Application No. 10-2023-0193916 filed on Dec. 28, 2023 in the Korean Intellectual Property Office (KIPO), the contents of which are herein incorporated by reference in their entirety.

### BACKGROUND

One or more semiconductor memory devices may be used in data storage devices. Examples of such data storage devices include solid state drives (SSDs). SSDs typically use flash memory and function as secondary storage. SSDs have various design and/or performance advantages over hard disk drives (HDDs). Examples include the absence of moving mechanical parts, higher data access speeds, stability, durability, and/or low power consumption. Various systems, e.g., a laptop computer, a car, an airplane, a drone, etc., have adopted SSDs for data storage.

Storage devices may operate based on a plurality of requests and/or commands received from host devices and various requests and/or commands may be provided to the storage devices depending on operating situation and/or environment. Therefore, research is being conducted on how to efficiently handle the requests and/or commands received from the host devices depending on the operating situation and/or environment.

### SUMMARY

Example implementations relate generally to semiconductor integrated circuits, and more particularly to methods of operating storage devices using dynamic read scheme, and storage devices performing the methods.

At least one example implementation of the present disclosure provides a method of operating a storage device capable of being implemented with flexible performance for various operating situations using a dynamic read scheme.

At least one example implementation of the present disclosure provides a storage device performing the method of operating the storage device.

According to example implementations, in a method of operating a storage device, a first command set corresponding to a first read scheme is transmitted to a nonvolatile memory based on a data read request having a first attribute. The first command set includes a data read command and a first number of status check commands. The data read request is received from an external device or internally generated in the storage device. A second command set corresponding to a second read scheme is transmitted to the nonvolatile memory based on the data read request having a second attribute. The second command set includes the data read command and a second number of status check commands. The second read scheme is different from the first read scheme. The second attribute is different from the first attribute. The second number is different from the first number. Read data corresponding to the data read command is received from the nonvolatile memory. When an attribute of the data read request is changed, it is dynamically changed whether to transmit the first command set corresponding to the first read scheme to the nonvolatile memory or the second command set corresponding to the second read scheme to the nonvolatile memory.

According to example implementations, a storage device includes at least one nonvolatile memory and a storage controller that controls an operation of the nonvolatile memory. The storage controller transmits a first command set corresponding to a first read scheme to the nonvolatile memory based on a data read request having a first attribute, transmits a second command set corresponding to a second read scheme to the nonvolatile memory based on the data read request having a second attribute, and receives read data corresponding to the data read command from the nonvolatile memory. The first command set includes a data read command and a first number of status check commands. The data read request is received from an external device or internally generated in the storage device. The second command set includes the data read command and a second number of status check commands. The second read scheme is different from the first read scheme. The second attribute is different from the first attribute. The second number is different from the first number. When an attribute of the data read request is changed, it is dynamically changed whether to transmit the first command set corresponding to the first read scheme to the nonvolatile memory or the second command set corresponding to the second read scheme to the nonvolatile memory.

According to example implementations, in a method of operating a storage device, a data read request is received from a host device located outside the storage device. An attribute of the data read request is determined. A first command set corresponding to a first read scheme is transmitted to a nonvolatile memory based on the data read request having a first attribute. The first command set includes a data read command and a first number of status check commands. A second command set corresponding to a second read scheme is transmitted to the nonvolatile memory based on the data read request having a second attribute. The second command set includes the data read command and a second number of status check commands. The second read scheme is different from the first read scheme. The second attribute is different from the first attribute. The second number is less than the first number. Read data is received from the nonvolatile memory. The read data corresponds to the data read command that is transmitted based on the first read scheme or the second read scheme. The first read scheme represents a scheme for improving latency performance of a data read operation. In the first read scheme, the data read command is transmitted to the nonvolatile memory, during a first time interval after the data read command is transmitted, a first operation in which the read data is retrieved from the nonvolatile memory is performed, after the first time interval, a first status check command for checking a completion of the first operation is transmitted to the nonvolatile memory, during a second time interval after the first time interval and after the first status check command is transmitted, a second operation in which the read data is output from the nonvolatile memory and a third operation in which an execution of a next command after the data read command is prepared are performed, and after the second time interval, a second status check command for checking a completion of the third operation is transmitted to the nonvolatile memory,. The second read scheme represents a scheme for improving bandwidth performance of the data read operation. In the second read scheme, the data read command is transmitted to the nonvolatile memory, during a third time interval after the data read command is transmitted, the first operation and the third operation are performed, after the third time interval, a third status check command for checking a completion of the first operation and the third operation is transmitted to the nonvolatile memory, and during a fourth time interval after the third time interval and after the third status check command is transmitted, the second operation is performed.

In the method of operating the storage device and the storage device according to example implementations, the read scheme for data from the nonvolatile memory may be dynamically and adaptively adjusted and/or controlled, depending on the attribute of the data read request. For example, performance (e.g., the latency performance or the bandwidth performance) with higher priority may be changed depending on the attribute of the data read request, and the data read operation may be performed with optimal performance depending on the operating situation. Accordingly, flexible performance for various operating situations may be implemented without changing physical factors, and thus data read performance may be improved or enhanced.

### BRIEF DESCRIPTION OF THE DRAWINGS

Illustrative, non-limiting example implementations will be more clearly understood from the following detailed description taken in conjunction with the accompanying drawings.

FIG. 1 is a flowchart illustrating a method of operating a storage device according to example implementations.

FIGS. 2A and 2B are diagrams for describing a method of operating a storage device according to example implementations.

FIG. 3 is a flowchart illustrating a method of operating a storage device according to example implementations.

FIG. 4 is a block diagram illustrating a storage device and a storage system including the storage device according to example implementations.

FIG. 5 is a block diagram illustrating an example of a storage controller included in a storage device according to example implementations.

FIG. 6 is a block diagram illustrating an example of a nonvolatile memory included in a storage device according to example implementations.

FIG. 7 is a flowchart illustrating an example of determining an attribute of a data read request in FIG. 3.

FIG. 8 is a diagram for describing an operation of FIG. 7.

FIG. 9 is a flowchart illustrating an example of determining an attribute of a data read request in FIG. 3.

FIG. 10 is a diagram for describing an operation of FIG. 9.

FIG. 11 is a flowchart illustrating an example of determining an attribute of a data read request in FIG. 3.

FIGS. 12A and 12B are diagrams for describing an operation of FIG. 11.

FIG. 13 is a flowchart illustrating an example of determining an attribute of a data read request in FIG. 3.

FIGS. 14A, 14B and 14C are diagrams for describing an operation of FIG. 13.

FIGS. 15 and 16 are block diagrams illustrating an example of a read manager included in a storage device of FIG. 4.

FIG. 17 is a block diagram illustrating a data center including a storage device according to example implementations.

### DETAILED DESCRIPTION

Various example implementations will be described more fully with reference to the accompanying drawings, in which implementations are shown. The present disclosure may, however, be embodied in many different forms and should not be construed as limited to the implementations set forth herein. Like reference numerals refer to like elements throughout this application.

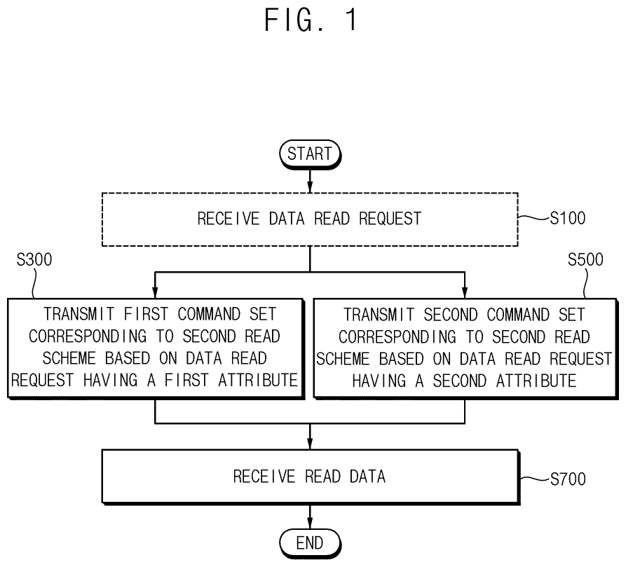

FIG. 1 is a flowchart illustrating a method of operating a storage device according to example implementations.

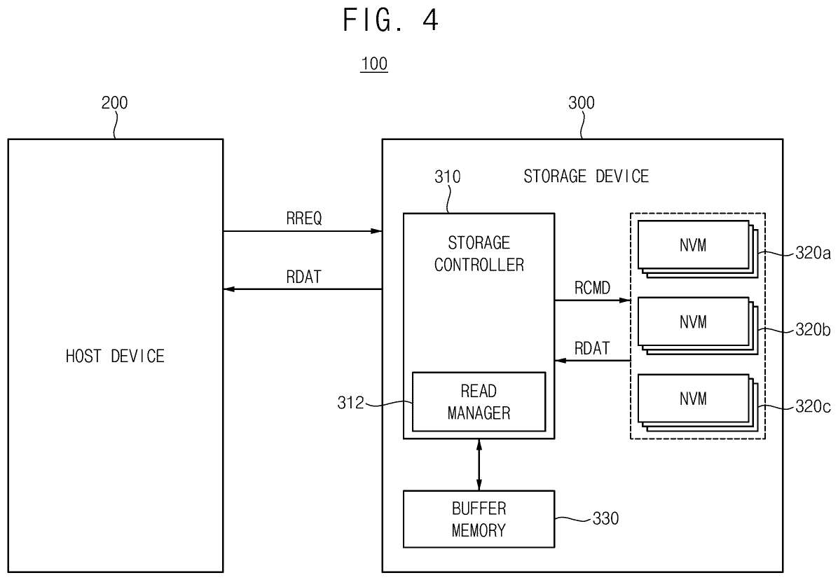

Referring to FIG. 1, a method of operating a storage device according to example implementations is performed by a storage device that includes a storage controller and at least one nonvolatile memory. The storage device may operate based on or in response to requests (or commands) received from a host device that is located outside the storage device. Configurations of the storage device and a storage system including the storage device will be described with reference to FIGS. 4, 5 and 6.

In the method of operating the storage device according to example implementations, a data read request may be received from the host device (operation S100). For example, the data read request may include a request for the host device to read and/or retrieve a specific storage space of the storage device. For example, a request received from the host device may be referred to as a host command, and the data read request may be referred to as a host read command. However, example implementations are not limited thereto, and the data read request may be internally generated in the storage device (e.g., by the storage controller).

Based on the data read request externally received (e.g., from the host device) or internally generated (e.g., by the storage controller) having a first attribute, a first command set corresponding to a first read scheme is transmitted to the nonvolatile memory (operation S300). The first command set includes a data read command and a first number of status check commands. For example, the first read scheme (or manner) may represent or indicate a read scheme for improving latency performance of a data read operation, and the first attribute (or property) may be a latency-oriented attribute for selecting and/or determining the first read scheme. For example, a command transmitted to the nonvolatile memory may be referred to as a memory command that is distinguished from the host command, and the data read command and the status check command may be referred to as a memory read command and a memory status check command, respectively. For example, the latency performance and the latency-oriented attribute may be referred to as quality of service (QoS) performance and QoS-oriented attribute, respectively.

Based on the data read request having a second attribute, a second command set corresponding to a second read scheme is transmitted to the nonvolatile memory (operation S500). The second command set includes the data read command and a second number of status check commands. The second read scheme is different from the first read scheme, the second attribute is different from the first attribute, and the second number (or quantity) is different from the first number (or quantity). For example, the second read scheme may represent a read scheme for improving bandwidth performance of the data read operation, and the second attribute may be a bandwidth-oriented attribute for selecting and/or determining the second read scheme.

Operations S300 and S500 may be selectively performed. In other words, only one of operations S300 and S500 may be performed for one data read request.

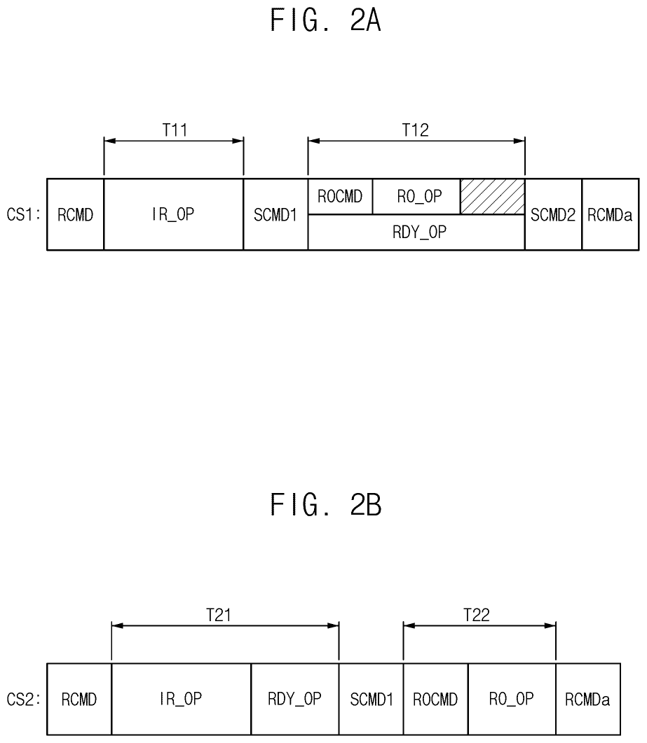

In some example implementations, the second number of status check commands included in the second command set corresponding to the second read scheme may be less than the first number of status check commands included in the first command set corresponding to the first read scheme. The first read scheme of operation S300 and the second read scheme of operation S500 will be described with reference to FIGS. 2A and 2B.

Read data corresponding to the data read command is received from the nonvolatile memory (operation S700). The read data is obtained by performing the data read operation based on the data read command, which is included in the first command set corresponding to the first read scheme and transmitted based on the first read scheme, or which is included in the second command set corresponding to the second read scheme and transmitted based on the second read scheme. For example, when the data read request is externally received from the host device, the read data may be output and transmitted to the host device. For example, when the data read request is internally generated by the storage controller, the read data may be internally processed by the storage controller.

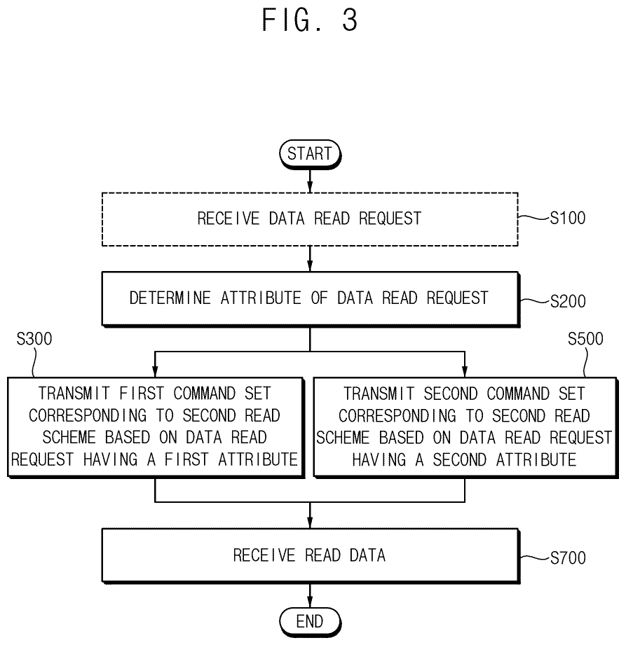

In some example implementations, when an attribute of the data read request is changed, it may be dynamically changed whether to transmit the first command set corresponding to the first read scheme to the nonvolatile memory or the second command set corresponding to the second read scheme to the nonvolatile memory. For example, an operation of determining the attribute of the data read request may be required, which will be described with reference to FIG. 3.

In the method of operating the storage device according to example implementations, the read scheme for data from the nonvolatile memory may be dynamically and adaptively adjusted and/or controlled, depending on the attribute of the data read request. For example, performance (e.g., the latency performance or the bandwidth performance) with higher priority may be changed depending on the attribute of the data read request, and the data read operation may be performed with optimal performance depending on the operating situation. Accordingly, flexible performance for various operating situations may be implemented without changing physical factors, and thus data read performance may be improved or enhanced.

FIGS. 2A and 2B are diagrams for describing a method of operating a storage device according to example implementations.

Referring to FIG. 2A, an example of a first command set CS1 corresponding to the first read scheme is illustrated. For example, the first command set CS1 corresponding to the first read scheme may be transmitted to the nonvolatile memory when operation S300 in FIG. 1 is performed, e.g., when the data read request has the first attribute.

First, a read data command RCMD may be transmitted from the storage controller to the nonvolatile memory. When the data read command RCMD is transmitted to the nonvolatile memory, the data read operation may be performed on the nonvolatile memory based on the data read command RCMD.

In some example implementations, the data read operation may include a plurality of unit operations that are sequentially performed. For example, the plurality of unit operations may include a first operation IR_OP, a second operation RO_OP and a third operation RDY_OP.

The first operation IR_OP may represent an operation in which the read data is retrieved from the nonvolatile memory (or an operation in which the read data is searched within the nonvolatile memory). For example, the nonvolatile memory may include a memory cell array including a plurality of memory cells and a page buffer circuit including a plurality of latches, and the first operation IR_OP may represent an operation of obtaining the read data from the memory cell array and storing the read data in the page buffer circuit. A time required for the first operation IR_OP may be referred to as a read time, e.g., “tR”. For example, the read time “tR” may be defined in the specification of the nonvolatile memory.

The second operation RO_OP may represent an operation in which the read data is output from the nonvolatile memory. For example, the second operation RO_OP may represent an operation of transmitting the read data stored in the page buffer circuit to the storage controller.

The third operation RDY_OP may represent an operation in which an execution of a next command after the data read command RCMD is prepared. For example, the third operation RDY_OP may represent a preparation operation required for the execution of the next command (e.g., another data read command RCMDa) after the data read operation corresponding to the data read command RCMD is completed. A time required for the third operation RDY_OP may be referred to as a ready-for-next-command time, e.g., “tRRC”. For example, the ready-for-next-command time “tRRC” may be defined in the specification of the nonvolatile memory.

In the first command set CS1 corresponding to the first read scheme illustrated in FIG. 2A, the second operation RO_OP and the third operation RDY_OP may be performed substantially simultaneously or concurrently.

For example, during a first time interval T11 after the data read command RCMD is transmitted, the first operation IR_OP may be performed. For example, the first time interval T11 may correspond to the read time “tR”. While the first operation IR_OP is performed, the storage controller may measure the read time “tR”. For example, the storage controller may include a timer, and may set the timer to measure the read time “tR”.

For example, after the first time interval T11, a first status check command SCMD1 for checking or identifying a completion of the first operation IR_OP may be transmitted from the storage controller to the nonvolatile memory. For example, it may be checked, based on the first status check command SCMD1, whether the read time “tR” has been completed (e.g., whether the read time “tR” defined in the specification has elapsed). The status check operation may be repeated until the read time “tR” is completed (e.g., until a response to the first status check command SCMD1 has a ready state).

For example, after the read time “tR” is completed, e.g., during a second time interval T12 after the first time interval T11 and after the first status check command SCMD1 is transmitted, the third operation RDY_OP may be performed. For example, the second time interval T12 may correspond to the ready-for-next-command time “tRRC”. While the third operation RDY_OP is performed, the storage controller may measure the ready-for-next-command time “tRRC”. For example, the storage controller may set the timer to measure the ready-for-next-command time “tRRC”.

For example, during the second time interval T12, the second operation RO_OP and the third operation RDY_OP may be performed substantially simultaneously. For example, an output command ROCMD for outputting the read data may be transmitted from the storage controller to the nonvolatile memory, and the second operation RO_OP in which the read data is transmitted from the nonvolatile memory to the storage controller may be performed based on the output command ROCMD. For example, the output command ROCMD may be a read direct memory access (DMA) command, and the second operation RO_OP may be a read DMA operation.

For example, after the second time interval T12, a second status check command SCMD2 for checking a completion of the third operation RDY_OP may be transmitted from the storage controller to the nonvolatile memory. For example, it may be checked, based on the second status check command SCMD2, whether the ready-for-next-command time “tRRC” has been completed (e.g., whether the ready-for-next-command time “tRRC” defined in the specification has elapsed). The status check operation may be repeated until the ready-for-next-command time “tRRC” is completed (e.g., until a response to the second status check command SCMD2 has a ready state).

In some example implementations, the first status check command SCMD1 and the second status check command SCMD2 may be the same type of command with the same field configuration.

For example, after the ready-for-next-command time “tRRC” is completed, e.g., after the second time interval T12 and after the second status check command SCMD2 is transmitted, the next command (e.g., another data read command RCMDa) may be transmitted from the storage controller to the nonvolatile memory. Based on the next command, the data read operation similar to those described above may be performed on the nonvolatile memory.

In some example implementations, the first number of the status check commands SCMD1 and SCMD2 that are included in the first command set CS1 corresponding to the first read scheme of FIG. 2A may be two. For example, the above-described two status check operations may be performed based on two status check commands SCMD1 and SCMD2.

In the first command set CS1 corresponding to the first read scheme illustrated in FIG. 2A, the timer for the read time “tR” and the timer for the ready-for-next-command time “tRRC” may be set separately and/or independently, the second operation RO_OP of transmitting the read data may be performed during a time interval corresponding to the ready-for-next-command time “tRRC” (e.g., during the second time interval T12), and thus relatively high latency performance or QoS performance may be achieved or obtained during the data read operation.

However, the ready-for-next-command time “tRRC” may be defined as the minimum time in the specification of the nonvolatile memory. Therefore, in the first command set CS1 corresponding to the first read scheme illustrated in FIG. 2A, even if the second operation RO_OP is completed, the next command may not be executed until the ready-for-next-command time “tRRC” is completed, and thus a vacancy time (e.g., hatched portion in FIG. 2A) may occur between the second operation RO_OP and the next command. In addition, the transmission of the second status check command SCMD2 may be required to check the completion of the ready-for-next-command time “tRRC” in the example of FIG. 2A, and thus the bandwidth performance may be relatively degraded during the data read operation due to time occupied by the second status check command SCMD2 in signal transmission between the storage controller and the nonvolatile memory.

Referring to FIG. 2B, an example of a second command set CS2 corresponding to the second read scheme is illustrated. For example, the second command set CS2 corresponding to the second read scheme may be transmitted to the nonvolatile memory when operation S500 in FIG. 1 is performed, e.g., when the data read request has the second attribute. The descriptions repeated with or overlapping with descriptions of FIG. 2A will be omitted in the interest of brevity.

First, the data read command RCMD may be transmitted from the storage controller to the nonvolatile memory, which is substantially the same as that described with reference to FIG. 2A.

In the second command set CS2 corresponding to the second read scheme illustrated in FIG. 2B, the first operation IR_OP and the third operation RDY_OP may be performed continuously or sequentially without delay.

For example, during a third time interval T21 after the data read command RCMD is transmitted, the first operation IR_OP may be performed first, and then the third operation RDY_OP may be performed later, and there may be no additional and/or unnecessary time interval between the first operation IR_OP and the third operation RDY_OP. For example, the third time interval T21 may correspond to the sum of the read time “tR” and the ready-for-next-command time “tRRC”. While the first operation IR_OP and the third operation RDY_OP are performed, the storage controller may measure the read time “tR” and the ready-for-next-command time “tRRC”. For example, the storage controller may set the timer to measure the read time “tR” and the ready-for-next-command time “tRRC”. Therefore, the third time interval T21 in FIG. 2B may be longer than the first time interval T11 in FIG. 2A.

For example, after the third time interval T21, a third status check command SCMD1 for checking a completion of the first operation IR_OP and the third operation RDY_OP may be transmitted from the storage controller to the nonvolatile memory. For example, the third status check command SCMD1 in FIG. 2B may be substantially the same as the first status check command SCMD1 in FIG. 2A. For example, it may be checked, based on the third status check command SCMD1, whether the read time “tR” and the ready-for-next-command time “tRRC” have been completed (e.g., whether the read time “tR” and the ready-for-next-command time “tRRC” defined in the specification have elapsed). The status check operation may be repeated until the read time “tR” and the ready-for-next-command time “tRRC” are completed (e.g., until a response to the third status check command SCMD3 has a ready state).

For example, after the read time “tR” and the ready-for-next-command time “tRRC” are completed, e.g., during a fourth time interval T22 after the third time interval T21 and after the third status check command SCMD1 is transmitted, the second operation RO_OP may be performed.

For example, after the fourth time interval T22, the next command (e.g., another data read command RCMDa) may be transmitted from the storage controller to the nonvolatile memory.

In some example implementations, the second number of the status check command SCMD1 included in the second command set CS2 corresponding to the second read scheme of FIG. 2B may be one. For example, the above-described single status check operation may be performed based on one status check command SCMD1. In other words, it may not wait for another status check command (e.g., SCMD2) after the completion of the second operation RO_OP, and thus the fourth time interval T22 in FIG. 2B may be shorter than the second time interval T12 in FIG. 2A.

In the second command set CS2 corresponding to the second read scheme illustrated in FIG. 2B, the timer for the read time “tR” and the timer for the ready-for-next-command time “tRRC” may be set at once or may be merged, the second operation RO_OP of transmitting the read data may be performed after both the read time “tR” and the ready-for-next-command time “tRRC” are completed (e.g., during the fourth time interval T22), and thus the latency performance may be relatively degraded during the data read operation.

However, in the second command set CS2 corresponding to the second read scheme illustrated in FIG. 2B, the next command may be received immediately after the second operation (RO_OP is completed, and thus the vacancy time in FIG. 2A may not occur between the second operation RO_OP and the next command. In addition, the completion of the read time “tR” and the ready-for-next-command time “tRRC” may be checked at once using one status check command SCMD1, and there may be no need to transmit the second status check command SCMD2 in FIG. 2A for checking the completion of the ready-for-next-command time “tRRC”. Therefore, the number of commands transmitted between the storage controller and the nonvolatile memory may be reduced, and thus relatively high bandwidth performance may be achieved during the data read operation.

Conventionally, only the first read scheme was used to perform the data read operation. In this case, there was an advantage in latency or QoS performance, however, there was a problem in that read performance is degraded when high bandwidth is required, such as a random read operation or a sequential read operation.

In the method of operating the storage device according to example implementations, the data read scheme may be determined flexibly and/or selectively, depending on the performance prioritized by the data read request, e.g., depending on whether the data read request has the latency-oriented attribute or the bandwidth-oriented attribute. For example, the first command set CS1 corresponding to the first read scheme of FIG. 2A may be used to improve the latency performance of the data read operation, or the second command set CS2 corresponding to the second read scheme of FIG. 2B may be used to improve the bandwidth performance of the data read operation. Accordingly, the storage device may be implemented with improved or enhanced data read performance.

FIG. 3 is a flowchart illustrating a method of operating a storage device according to example implementations. The descriptions repeated with or overlapping with descriptions of FIG. 1 will be omitted in the interest of brevity.

Referring to FIG. 3, in a method of operating a storage device according to example implementations, operations S100, S300, S500 and S700 may be substantially the same as those described with reference to FIG. 1.

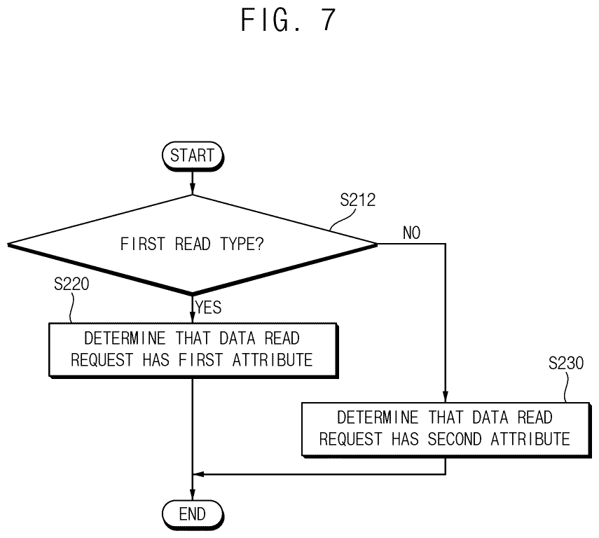

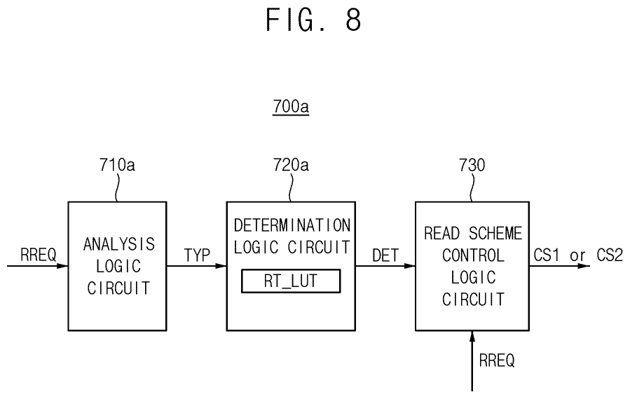

Before operation S300 or operation S500 is performed, the attribute of the data read request may be determined (operation S200). For example, the attribute of the data read request may be determined based on at least one of a type of the data read request, a queue depth (QD) of the storage device, a characteristic of the host device that provides the data read request, and characteristics of a plurality of physical functions (PFs) that are included in the storage device. The queue depth may represent the number of a plurality of data input/output (I/O) requests waiting to be performed in the storage device. Operation S300 or operation S500 may be performed based on a result of the determination in operation S200. Operation S200 will be described with reference to FIGS. 7, 9, 11 and 13.

FIG. 4 is a block diagram illustrating a storage device and a storage system including the storage device according to example implementations.

Referring to FIG. 4, a storage system 100 includes a host device 200 and a storage device 300.

The host device 200 controls overall operations of the storage system 100. Although not illustrated in FIG. 2, the host device 200 may include a host processor and a host memory. The host processor may control an operation of the host device. For example, the host processor may execute an operating system (OS). The host memory may store instructions and/or data that are executed and/or processed by the host processor.

The storage device 300 is accessed by the host device 200. The storage device 300 may include a storage controller 310, a plurality of nonvolatile memories 320a, 320b and 320c, and a buffer memory 330.

The storage controller 310 may control an operation of the storage device 300.

For example, the storage controller 310 may control the operation of the storage device 300 and may control an operation of exchanging data between the host device 200 and the storage device 300, based on various data I/O requests received from the host device 200. For example, the storage controller 310 may generate various data I/O commands for controlling operations of the plurality of nonvolatile memories 320a to 320c, may transmit the data I/O commands to the plurality of nonvolatile memories 320a to 320c, and may control an operation of exchanging data with the plurality of nonvolatile memories 320a to 320c.

For example, the storage controller 310 may receive a data read request RREQ as one of the data I/O requests from the host device 200, and may transmit read data RDAT corresponding to the data read request RREQ to the host device 200. For example, the storage controller 310 may transmit a data read command RCMD corresponding to the data read request RREQ as one of the data I/O commands to the plurality of nonvolatile memories 320a to 320c, and may receive the read data RDAT corresponding to the data read command RCMD from the plurality of nonvolatile memories 320a to 320c.

The plurality of nonvolatile memories 320a to 320c may be controlled by the storage controller 310, and may store a plurality of data. For example, the plurality of nonvolatile memories 320a to 320c may store meta data, user data, or the like.

In some example implementations, each of the plurality of nonvolatile memories 320a to 320c may include a NAND flash memory. In other example implementations, each of the plurality of nonvolatile memories 320a to 320c may include one of an electrically erasable programmable read only memory (EEPROM), a phase-change random access memory (PRAM), a resistive random access memory (RRAM), a nano floating gate memory (NFGM), a polymer random access memory (PoRAM), a magnetic random access memory (MRAM), a ferroelectric random access memory (FRAM), or the like.

The buffer memory 330 may store instructions and/or data that are executed and/or processed by the storage controller 310, and may temporarily store data stored in or to be stored into the plurality of nonvolatile memories 320a to 320c. For example, the buffer memory 330 may include at least one of various volatile memories, e.g., a static random access memory (SRAM), a dynamic random access memory (DRAM), or the like.

To perform the method of operating the storage device according to example implementations described with reference to FIGS. 1 through 3, the storage controller 310 may include a read manager 312. For example, when the data read request RREQ has the first attribute (e.g., latency-oriented attribute), the storage controller 310 and/or the read manager 312 may transmit the first command set CS1 corresponding to the first read scheme to at least one of the plurality of nonvolatile memories 320a to 320c. For example, when the data read request RREQ has the second attribute (e.g., a bandwidth-oriented attribute), the storage controller 310 and/or the read manager 312 may transmit the second command set CS2 corresponding to the second read scheme to at least one of the plurality of nonvolatile memories 320a to 320c. As illustrated in FIGS. 2A and 2B, the first command set CS1 may include the data read command RCMD and the first number of status check commands SCMD1 and SCMD2, and the second command set CS2 may include the data read command RCMD and the second number of status check commands SCMD1. Thereafter, the storage controller 310 and/or the read manager 312 may receive the read data RDAT corresponding to the data read command RCMD from at least one of the plurality of nonvolatile memories 320a to 320c. In addition, the storage controller 310 and/or the read manager 312 may determine the attribute of the data read request RREQ.

A configuration of the read manager 312 will be described with reference to FIGS. 8, 10, 12B, 14C and 15.

Although FIG. 4 illustrates that the data read request RREQ is received from the host device 200, example implementations are not limited thereto, and the data read request may be internally generated by the storage controller 310.

In some example implementations, the storage device 300 may be a solid state drive (SSD), a universal flash storage (UFS), a multimedia card (MMC) or an embedded multimedia card (eMMC). In other example implementations, the storage device 300 may be one of a secure digital (SD) card, a micro SD card, a memory stick, a chip card, a universal serial bus (USB) card, a smart card, a compact flash (CF) card, or the like.

In some example implementations, the storage device 300 may be connected to the host device 200 via a block accessible interface which may include, for example, a UFS, an eMMC, a nonvolatile memory express (NVMe) bus, a small computer small interface (SCSI) bus, a serial attached SCSI (SAS) bus, a universal serial bus (USB), a peripheral component interconnect (PCI) express (PCIe) bus, an advanced technology attachment (ATA) bus, a parallel ATA (PATA) bus, a serial ATA (SATA) bus, a compute express link (CXL) bus, or the like. The storage device 300 may use a block accessible address space corresponding to an access size of the plurality of nonvolatile memories 320a to 320c to provide the block accessible interface to the host device 200, for allowing the access by units of a memory block with respect to data stored in the plurality of nonvolatile memories 320a to 320c.

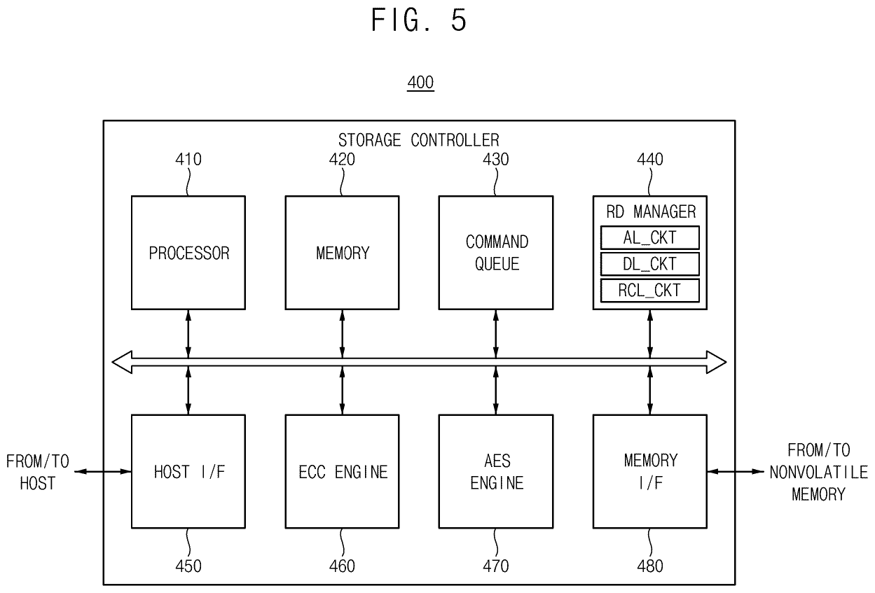

FIG. 5 is a block diagram illustrating an example of a storage controller included in a storage device according to example implementations.

Referring to FIG. 5, a storage controller 400 may include a processor 410, a memory 420, a command queue 430, a read (RD) manager 440, a host interface (I/F) 450, an error correction code (ECC) engine 460, an advanced encryption standard (AES) engine 470 and a memory interface 480.

The processor 410 may control an operation of the storage controller 400 in response to a request received via the host interface 450 from a host device (e.g., the host device 200 in FIG. 4). For example, the processor 410 may control an operation of a storage device (e.g., the storage device 300 in FIG. 4), and may control respective components of the storage device by employing firmware for operating the storage device.

The memory 420 may store instructions and data executed and processed by the processor 410. For example, the memory 420 may be implemented with a volatile memory, such as a DRAM, a SRAM, a cache memory, or the like.

The command queue 430 may receive and queue a plurality of data I/O requests (e.g., a plurality of host I/O commands) and/or a plurality of data I/O commands (e.g., a plurality of memory I/O commands) for accessing a plurality of nonvolatile memories (e.g., the plurality of nonvolatile memories 320a to 320c in FIG. 4) included in the storage device.

In some example implementations, although not illustrated in detail, the command queue 430 may include a host command queue for the plurality of data I/O requests and a memory command queue for the plurality of data I/O commands. For example, each of the host command queue and the memory command queue may include a submission queue and a completion queue. For example, each of the submission queue and the completion queue may include a ring buffer.

The read manager 440 may be substantially the same as the read manager 312 in FIG. 4. The read manager 440 may include an analysis logic circuit AL_CKT, a determination logic circuit DL_CKT and a read scheme control logic circuit RCL_CKT that are used to perform the method of operating the storage device according to example implementations. Operations of the analysis logic circuit AL_CKT, the determination logic circuit DL_CKT and the read scheme control logic circuit RCL_CKT will be described with reference to FIGS. 8, 10, 12B, 14C and 15.

The host interface 450 may provide physical connections between the host device and the storage device. The host interface 450 may provide an interface corresponding to a bus format of the host device for communication between the host device and the storage device. In some example implementations, the bus format of the host device may be a small computer system interface (SCSI) or a serial attached SCSI (SAS) interface. In other example implementations, the bus format of the host device may be a USB, a peripheral component interconnect (PCI) express (PCIe), an advanced technology attachment (ATA), a parallel ATA (PATA), a serial ATA (SATA), a nonvolatile memory (NVM) express (NVMe), a compute express link (CXL), etc., format.

The ECC engine 460 for error correction may perform coded modulation using a Bose-Chaudhuri-Hocquenghem (BCH) code, a low density parity check (LDPC) code, a turbo code, a Reed-Solomon code, a convolution code, a recursive systematic code (RSC), a trellis-coded modulation (TCM), a block coded modulation (BCM), etc., or may perform ECC encoding and ECC decoding using above-described codes or other error correction codes.

The AES engine 470 may perform at least one of an encryption operation and a decryption operation on data input to the storage controller 400 by using a symmetric-key algorithm. Although not illustrated in detail, the AES engine 470 may include an encryption module and a decryption module. For example, the encryption module and the decryption module may be implemented as separate modules. As another example, one module capable of performing both encryption and decryption operations may be implemented in the AES engine 470.

The memory interface 480 may exchange data with the plurality of nonvolatile memories. The memory interface 480 may transfer data to the nonvolatile memory, or may receive data read from the plurality of nonvolatile memories. In some example implementations, the memory interface 480 may be connected to the plurality of nonvolatile memories via one channel. In other example implementations, the memory interface 480 may be connected to the plurality of nonvolatile memories via two or more channels. For example, the memory interface 480 may be configured to comply with a standard protocol, such as Toggle or open NAND flash interface (ONFI).

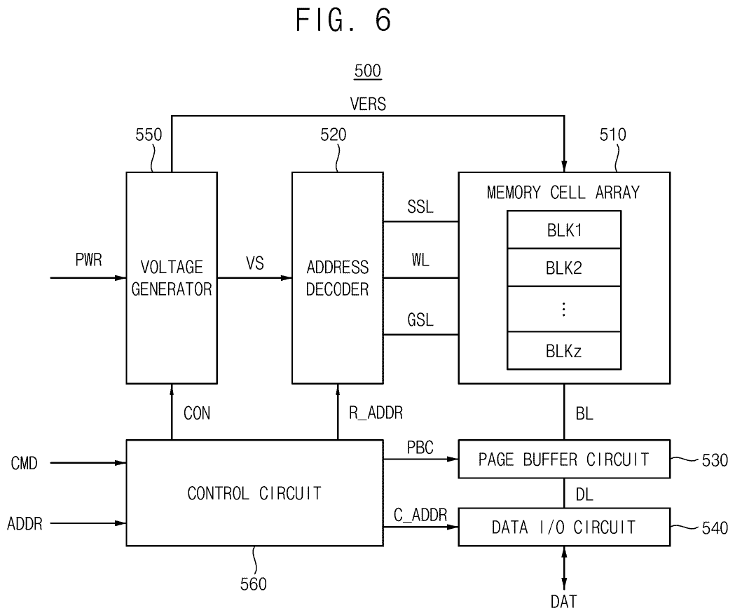

FIG. 6 is a block diagram illustrating an example of a nonvolatile memory included in a storage device according to example implementations.

Referring to FIG. 6, a nonvolatile memory 500 includes a memory cell array 510, an address decoder 520, a page buffer circuit 530, a data input/output (I/O) circuit 540, a voltage generator 550 and a control circuit 560.

The memory cell array 510 is connected to the address decoder 520 via a plurality of string selection lines SSL, a plurality of wordlines WL and a plurality of ground selection lines GSL. The memory cell array 510 is further connected to the page buffer circuit 530 via a plurality of bitlines BL. The memory cell array 510 may include a plurality of memory cells (e.g., a plurality of nonvolatile memory cells) that are connected to the plurality of wordlines WL and the plurality of bitlines BL. The memory cell array 510 may be divided into a plurality of memory blocks BLK1, BLK2, . . . , BLKz each of which includes memory cells. In addition, each of the plurality of memory blocks BLK1 to BLKz may be divided into a plurality of pages.

In some example implementations, the plurality of memory cells included in the memory cell array 510 may be arranged in a two-dimensional (2D) array structure or a three-dimensional (3D) vertical array structure. The 3D vertical array structure may include vertical cell strings that are vertically oriented such that at least one memory cell is located over another memory cell. The at least one memory cell may comprise a charge trap layer. The following patent documents, which are hereby incorporated by reference in their entireties, describe configurations for a memory cell array including a 3D vertical array structure, in which the three-dimensional memory array is configured as a plurality of levels, with wordlines and/or bitlines shared between levels: U.S. Pat. Nos. 7,679,133; 8,553,466; 8,654,587; 8,559,235; and U.S. Pat. Pub. No. 2011/0233648.

The control circuit 560 receives a command CMD and an address ADDR from a device external to the control circuit 560 (e.g., from the storage controller 310 in FIG. 4), and controls erasure, programming and read operations of the nonvolatile memory 500 based on the command CMD and the address ADDR. An erasure operation may include performing a sequence of erase loops, and a program operation may include performing a sequence of program loops. Each program loop may include a program operation and a program verification operation. Each erase loop may include an erase operation and an erase verification operation. The read operation may include a normal read operation and data recovery read operation.

For example, the control circuit 560 may generate control signals CON, which are used for controlling the voltage generator 550, and may generate a control signal PBC for controlling the page buffer circuit 530, based on the command CMD, and may generate a row address R_ADDR and a column address C_ADDR based on the address ADDR. The control circuit 560 may provide the row address R_ADDR to the address decoder 520 and may provide the column address C_ADDR to the data I/O circuit 540.

The address decoder 520 may be connected to the memory cell array 510 via the plurality of string selection lines SSL, the plurality of wordlines WL and the plurality of ground selection lines GSL. For example, in the data erase/write/read operations, the address decoder 520 may determine at least one of the plurality of wordlines WL as a selected wordline, may determine at least one of the plurality of string selection lines SSL as a selected string selection line, and may determine at least one of the plurality of ground selection lines GSL as a selected ground selection line, based on the row address R_ADDR.

The voltage generator 550 may generate voltages VS that are required for an operation of the nonvolatile memory 500 based on a power PWR and the control signals CON. The voltages VS may be applied to the plurality of string selection lines SSL, the plurality of wordlines WL and the plurality of ground selection lines GSL via the address decoder 520. In addition, the voltage generator 550 may generate an erase voltage VERS that is required for the data erase operation based on the power PWR and the control signals CON. The erase voltage VERS may be applied to the memory cell array 510 directly or via the bitline BL.

The page buffer circuit 530 may be connected to the memory cell array 510 via the plurality of bitlines BL. The page buffer circuit 530 may include a plurality of page buffers including a plurality of latches. The page buffer circuit 530 may store data DAT to be programmed into the memory cell array 510 or may read data DAT sensed from the memory cell array 510. In other words, the page buffer circuit 530 may operate as a write driver or a sensing amplifier depending on an operation mode of the nonvolatile memory 500.

The data I/O circuit 540 may be connected to the page buffer circuit 530 via data lines DL. The data I/O circuit 540 may provide the data DAT from the outside of the nonvolatile memory 500 to the memory cell array 510 via the page buffer circuit 530 or may provide the data DAT from the memory cell array 510 to a circuit device outside of the nonvolatile memory 500, based on the column address C_ADDR.

FIG. 7 is a flowchart illustrating an example of determining an attribute of a data read request in FIG. 3. FIG. 8 is a diagram for describing an operation of FIG. 7.

Referring to FIGS. 3 and 7, when determining the attribute of the data read request (operation S200), the attribute of the data read request may be determined based on the type of the data read request.

For example, when the type of the data read request that is obtained by analyzing the data read request is a first read type (operation S212: YES), it may be determined that the data read request has the first attribute (e.g., latency-oriented attribute) (operation S220), and then operation S300 may be performed to transmit the first command set CS1 corresponding to the first read scheme of FIG. 2A.

When the type of the data read request is a second read type different from the first read type (operation S212: NO), it may be determined that the data read request has the second attribute (e.g., bandwidth-oriented attribute) (operation S230), and then operation S500 may be performed to transmit the second command set CS2 corresponding to the second read scheme of FIG. 2B.

In some example implementations, the data read request may be or may include an external read request that is received from the host device located outside the storage device, an internal read request that is internally generated in the storage device, a random read request associated with or related to discontinuous logical addresses, and a sequential read request associated with or related to continuous logical addresses.

For example, if the data read request is the external read request, an attribute of the external read request may be determined as the first attribute or the second attribute, depending on a situation and/or a predetermined criterion. For example, different determination criteria or standards may be applied or employed depending on whether the storage device is intended for an enterprise, a server, a data center, or for a general client and/or user.

For example, if the data read request is the internal read request, e.g., a read request for an internal memory management operation such as read for a garbage collection and/or read for meta data, an attribute of the internal read request may be determined as the second attribute. However, example implementations are not limited thereto, and the attribute of the internal read request may be determined as the first attribute or may be determined as the first attribute or the second attribute depending on the situation and/or the predetermined criterion.

For example, if the data read request is the random read request or the sequential read request, an attribute of the random read request or the sequential read request may be determined as the second attribute. As described above, the random read operation and the sequential read operation may require relatively high bandwidth, and thus the attribute of the random read request or the sequential read request may be determined as the second attribute.

Referring to FIG. 8, an example of a read manager 700a that performs the operation of FIG. 7 is illustrated.

The read manager 700a may include an analysis logic circuit 710a, a determination logic circuit 720a and a read scheme control logic circuit 730.

The analysis logic circuit 710a may obtain a first parameter TYP by analyzing the data read request RREQ. For example, the first parameter TYP may represent a type of data read request RREQ, and may be referred to as a type parameter.

The determination logic circuit 720a may generate a determination signal DET that represents the attribute of the data read request RREQ based on the first parameter TYP. For example, when it is determined based on the first parameter TYP that the type of the data read request RREQ is the first read type, e.g., when it is determined that the attribute of the data read request RREQ is the first attribute, the determination signal DET may have a first value. For example, when it is determined based on the first parameter TYP that the type of the data read request RREQ is the second read type, e.g., when it is determined that the attribute of the data read request RREQ is the second attribute, the determination signal DET may have a second value different from the first value. For example, the determination signal DET in FIG. 8 may correspond to the result of determination by operations S212, S220 and S230 in FIG. 7.

In some example implementations, the determination logic circuit 720a may include a read type look-up table RT_LUT that includes a relationship or correspondence between a plurality of data read requests and whether the plurality of data read requests are the first read type or the second read type.

The read scheme control logic circuit 730 may generate the first command set CS1 corresponding to the first read scheme or the second command set CS2 corresponding to the second read scheme based on the data read request RREQ and the determination signal DET. For example, when the determination signal DET has the first value, the read scheme control logic circuit 730 may output the first command set CS1 corresponding to the first read scheme. For example, when the determination signal DET has the second value, the read scheme control logic circuit 730 may output the second command set CS2 corresponding to the second read scheme.

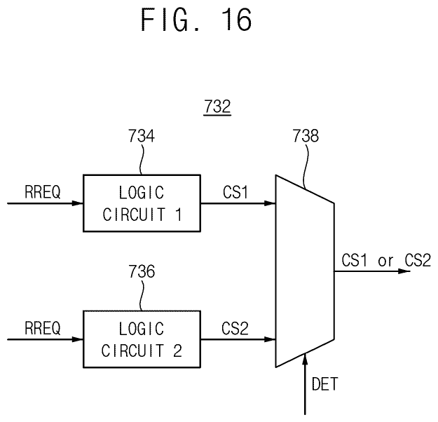

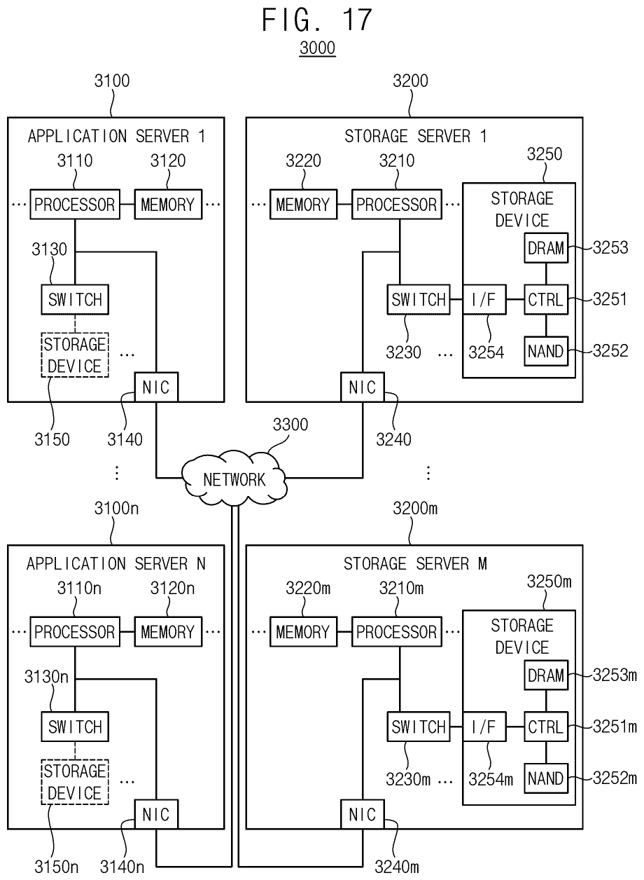

In some example implementations, the read scheme control logic circuit 730 may generate only one of the first command set CS1 corresponding to the first read scheme and the second command set CS2 corresponding to the second read scheme based on the determination signal DET. In some example implementations, as will be described with reference to FIG. 16, the read scheme control logic circuit 730 may generate both the first command set CS1 corresponding to the first read scheme and the second command set CS2 corresponding to the second read scheme, and may select and output one of the first command set CS1 and the second command set CS2 based on the determination signal DET.

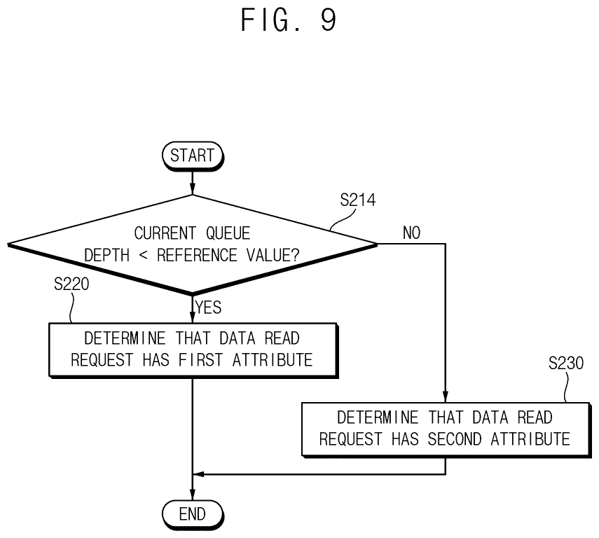

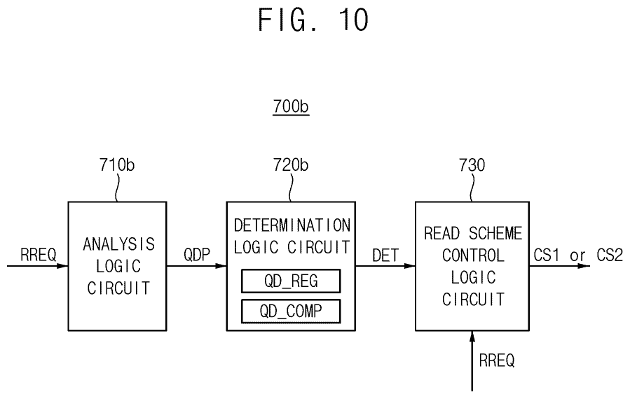

FIG. 9 is a flowchart illustrating an example of determining an attribute of a data read request in FIG. 3. FIG. 10 is a diagram for describing an operation of FIG. 9. The descriptions repeated with or overlapping with descriptions of FIGS. 7 and 8 will be omitted in the interest of brevity.

Referring to FIGS. 3 and 9, when determining the attribute of the data read request (operation S200), the attribute of the data read request may be determined based on the queue depth that represents the number of the plurality of data I/O requests waiting to be performed in the storage device. For example, the plurality of data I/O requests may be queued in the command queue 430 in FIG. 5, and the attribute of the data read request may be determined using a performance monitoring value and/or a cumulative performance monitoring value obtained by executing the I/O requests in real-time or during runtime.

For example, when a current queue depth, which is associated with the execution of the data read request obtained by analyzing the data read request, is less than a reference value (or reference queue depth) (operation S214: YES), e.g., when the current queue depth corresponds to a low queue depth state, it may be determined that the data read request has the first attribute (e.g., latency-oriented attribute) (operation S220). For example, the reference value may be a predetermined and prestored value.

When the current queue depth associated with the execution of the data read request is greater than or equal to the reference value (operation S214: NO), e.g., when the current queue depth corresponds to a high queue depth state, it may be determined that the data read request has the second attribute (e.g., bandwidth-oriented attribute) (operation S230).

Referring to FIG. 10, an example of a read manager 700b that performs the operation of FIG. 9 is illustrated.

The read manager 700b may include an analysis logic circuit 710b, a determination logic circuit 720b and a read scheme control logic circuit 730.

The analysis logic circuit 710b may obtain a second parameter QDP by analyzing the data read request RREQ. For example, the second parameter QDP may represent a current queue depth associated with an execution of the data read request RREQ, and may be referred to as a queue depth parameter.

The determination logic circuit 720b may generate a determination signal DET that represents the attribute of the data read request RREQ based on the second parameter QDP. For example, when it is determined based on the second parameter QDP that the current queue depth is less than the reference value, e.g., when it is determined that the attribute of the data read request RREQ is the first attribute, the determination signal DET may have the first value. For example, when it is determined based on the second parameter QDP that the current queue depth is greater than or equal to the reference value, e.g., when it is determined that the attribute of the data read request RREQ is the second attribute, the determination signal DET may have the second value. For example, the determination signal DET in FIG. 10 may correspond to the result of determination by operations S214, S220 and S230 in FIG. 9.

In some example implementations, the determination logic circuit 720b may include a queue depth register QD_REG that stores the current queue depth or the second parameter QDP, and a queue depth comparator QD_COMP that compares the current queue depth with the reference value.

The read scheme control logic circuit 730 may be substantially the same as that described with reference to FIG. 8.

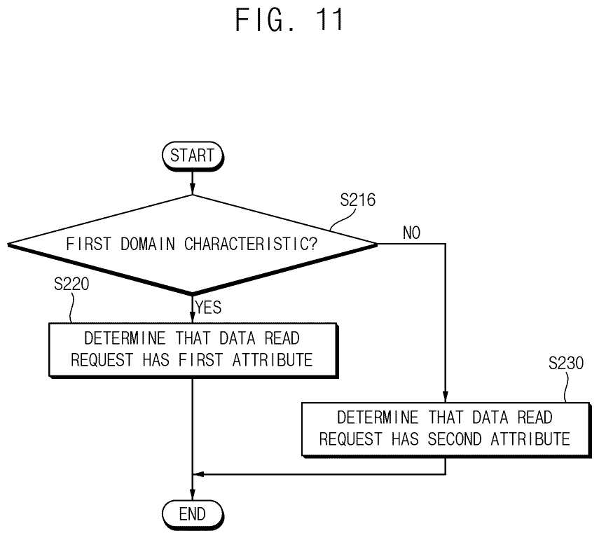

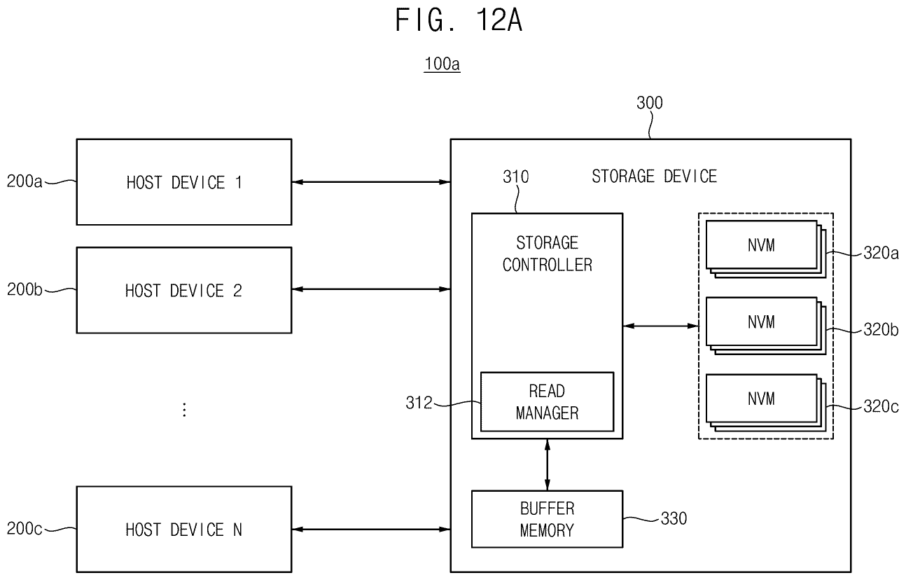

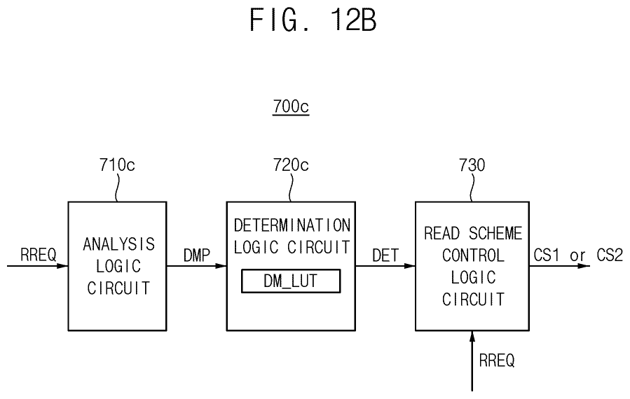

FIG. 11 is a flowchart illustrating an example of determining an attribute of a data read request in FIG. 3. FIGS. 12A and 12B are diagrams for describing an operation of FIG. 11. The descriptions repeated with or overlapping with descriptions of FIGS. 7 and 8 will be omitted in the interest of brevity.

Referring to FIGS. 3 and 11, when determining the attribute of the data read request (operation S200), the data read request may be received from the host device located outside the storage device, and the attribute of the data read request may be determined based on the characteristic of the host device that provides the data read request. For example, the storage device may be controlled by a plurality of host devices, and a plurality of domains may be formed by the plurality of host devices. For example, the characteristic of the host device may include characteristics of the plurality of domains, and the attribute of the data read request may be determined using the characteristics of the plurality of domains.

For example, when a domain characteristic, which is associated with the data read request obtained by analyzing the data read request, is a first domain characteristic (operation S216: YES), it may be determined that the data read request has the first attribute (e.g., latency-oriented attribute) (operation S220). For example, the first domain characteristic may represent a characteristic that prioritizes the latency performance (e.g., a characteristic having the latency performance as target performance).

When the domain characteristic associated with the data read request is a second domain characteristic different from the first domain characteristic (operation S216: NO), it may be determined that the data read request has the second attribute (e.g., bandwidth-oriented attribute) (operation S230). For example, the second domain characteristic may represent a characteristic that prioritizes the bandwidth performance (e.g., a characteristic having the bandwidth performance as target performance).

Referring to FIG. 12A, an example of a storage system 100a that performs the operation of FIG. 11 is illustrated. The descriptions repeated with or overlapping with descriptions of FIG. 4 will be omitted in the interest of brevity.

The storage system 100a may include a plurality of host devices 200a, 200b and 200c and a storage device 300.

Each of the plurality of host devices 200a to 200c may be substantially the same as the host device 200 in FIG. 4, and may independently access the storage device 300. For example, the plurality of host devices 200a to 200c may be computing nodes that operate independently from each other.

In some example implementations, the plurality of host devices 200a to 200c may be physically different devices. In some example implementations, the plurality of host devices 200a to 200c may be different virtual machines that operate in one physical device. For example, the virtual machines may be implemented in a virtualization environment using single root I/O virtualization (SR-IOV).

A plurality of domains may be formed by the plurality of host devices 200a to 200c. For example, the first host device 200a may form a first domain, the second host device 200b may form a second domain, and the N-th host device 200c may form an N-th domain, where N is a positive integer greater than or equal to two.

The storage device 300 may support multi-host and/or multi-tenancy. For example, the storage device 300 may be substantially the same as the storage device 300 in FIG. 4, and may operate under the control of the plurality of host devices 200a to 200c.

In the method of operating the storage device 300 included in the storage system 100a, when the data read request RREQ is received from one of the plurality of host devices 200a to 200c, the storage device 300 may operate based on the first read scheme or the second read scheme depending on the characteristic (e.g., domain characteristic) of the host device that provides the data read request RREQ.

Referring to FIG. 12B, an example of a read manager 700c that performs the operation of FIG. 11 is illustrated.

The read manager 700c may include an analysis logic circuit 710c, a determination logic circuit 720c and a read scheme control logic circuit 730.

The analysis logic circuit 710c may obtain a third parameter DMP by analyzing the data read request RREQ. For example, the third parameter DMP may represent a domain characteristic associated with the data read request RREQ, and may be referred to as a domain parameter.

The determination logic circuit 720c may generate a determination signal DET that represents the attribute of the data read request RREQ based on the third parameter DMP. For example, when it is determined based on the third parameter DMP that the domain characteristic is the first domain characteristic, e.g., when it is determined that the attribute of the data read request RREQ is the first attribute, the determination signal DET may have the first value. For example, when it is determined based on the third parameter DMP that the domain characteristic is the second domain characteristic, e.g., when it is determined that the attribute of the data read request RREQ is the second attribute, the determination signal DET may have the second value. For example, the determination signal DET in FIG. 12B may correspond to the result of determination by operations S216, S220 and S230 in FIG. 11.

In some example implementations, the determination logic circuit 720c may include a domain lookup table DM_LUT that includes a relationship or correspondence between a plurality of domains and whether the plurality of domains have the first domain characteristic or the second domain characteristic.

The read scheme control logic circuit 730 may be substantially the same as that described with reference to FIG. 8.

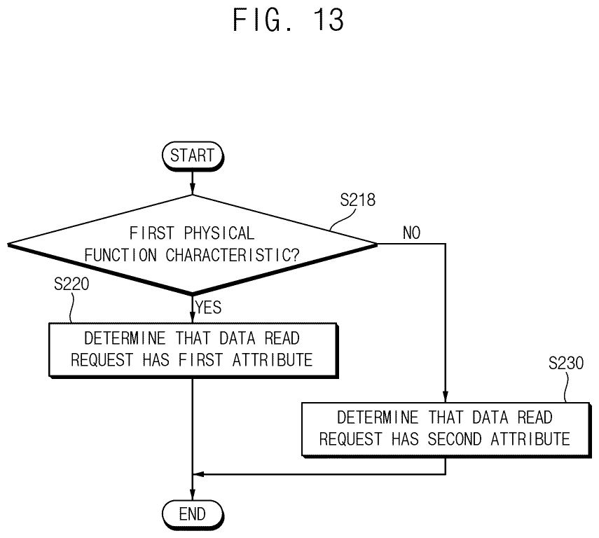

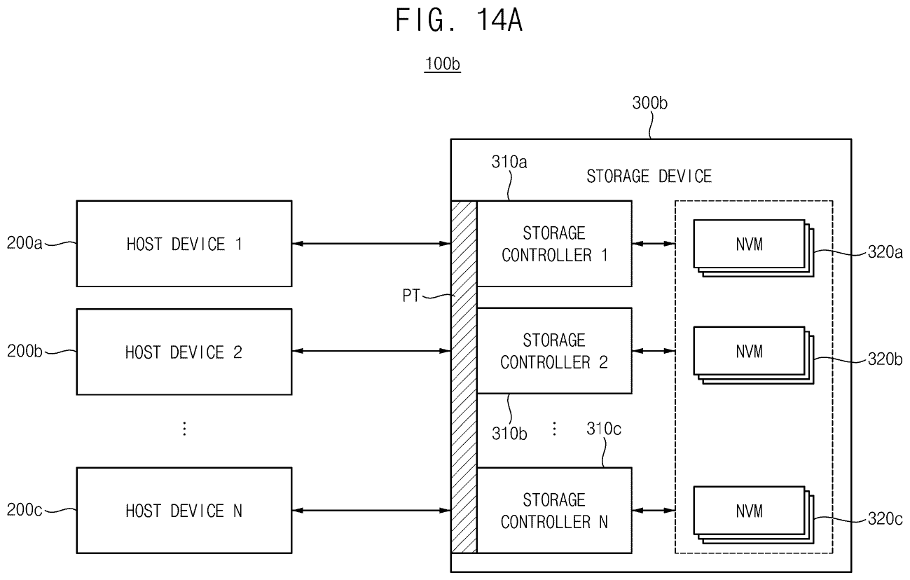

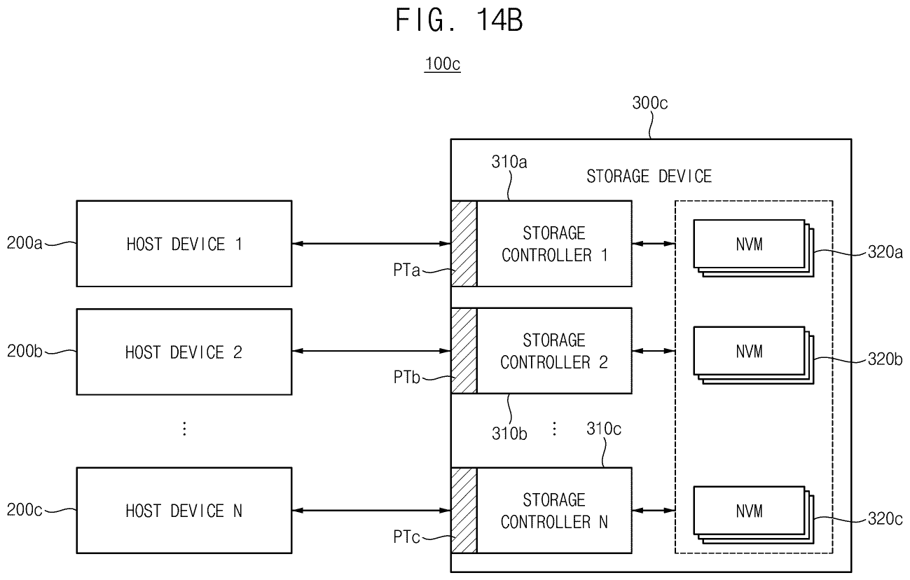

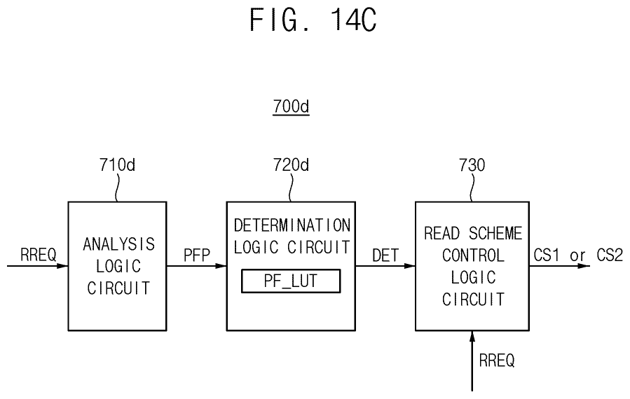

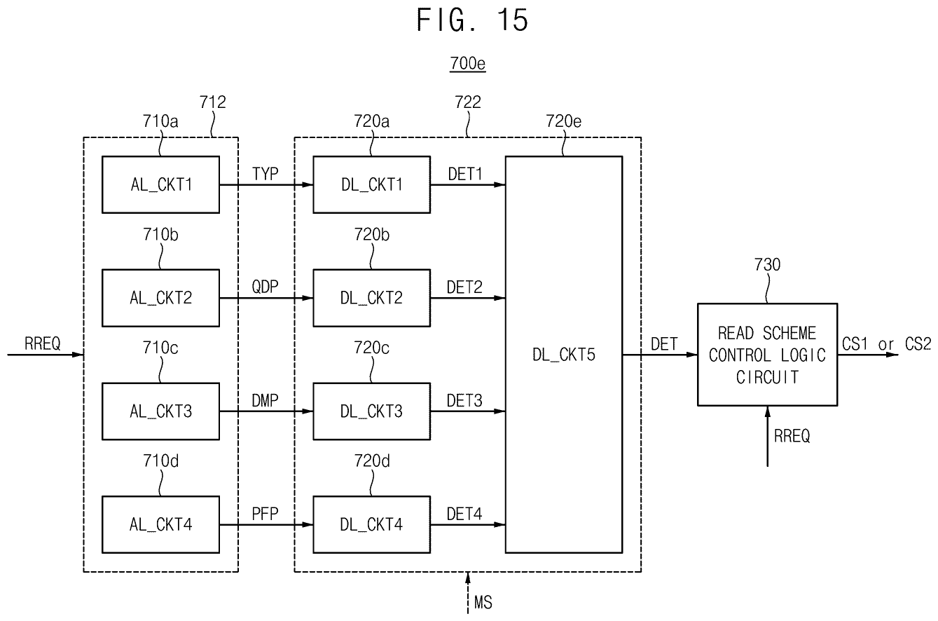

FIG. 13 is a flowchart illustrating an example of determining an attribute of a data read request in FIG. 3. FIGS. 14A, 14B and 14C are diagrams for describing an operation of FIG. 13. The descriptions repeated with or overlapping with descriptions of FIGS. 7 and 8 will be omitted in the interest of brevity.

Referring to FIGS. 3 and 13, when determining the attribute of the data read request (operation S200), the storage device may include the plurality of physical functions, and the attribute of the data read request may be determined based on the characteristics of the plurality of physical functions.

For example, when a physical functional characteristic, which is associated with the data read request obtained by analyzing the data read request, is a first physical functional characteristic (operation S218: YES), it may be determined that the data read request has the first attribute (e.g., latency-oriented attribute) (operation S220). For example, the first physical functional characteristic may represent a characteristic that prioritizes the latency performance.

When the physical functional characteristic associated with the data read request is a second physical functional characteristic different from the first physical functional characteristic (operation S218: NO), it may be determined that the data read request has the second attribute (e.g., bandwidth-oriented attribute) (operation S230). For example, the second physical functional characteristic may represent a characteristic that prioritizes the bandwidth performance.

Referring to FIG. 14A, an example of a storage system 100b that performs the operation of FIG. 13 is illustrated. The descriptions repeated with or overlapping with descriptions of FIGS. 4 and 12A will be omitted in the interest of brevity.

The storage system 100b may include a plurality of host devices 200a, 200b and 200c and a storage device 300b.

The storage device 300b may include a plurality of storage controllers 310a, 310b and 310c, and a plurality of nonvolatile memories 320a, 320b and 320c. The plurality of storage controllers 310a to 310c may communicate with the plurality of host devices 200a to 200c through one physical port PT. For convenience of illustration, a component corresponding to the buffer memory 330 in FIG. 4 is omitted.

The storage device 300b may support multi-host and/or multi-tenancy. For example, the first host device 200a may communicate with the first storage controller 310a to access the storage device 300b, the second host device 200b may communicate with the second storage controller 310b to access the storage device 300b, and the N-th host device 200c may communicate with the N-th storage controller 310c to access the storage device 300b.

A plurality of physical functions may be formed by the plurality of storage controllers 310a to 310c. For example, a physical function may refer to each storage controller corresponding to each host device. For example, the first storage controller 310a may form a first physical function, the second storage controller 310b may form a second physical function, and the N-th storage controller 310c may form an N-th physical function.

In some example implementations, the physical function may be a hardware or software component configured to provide a function defined by the NVMe interface standard. For example, the physical function may refer to an NVMe controller, and the NVMe controller may be implemented in the form of software, hardware, or a combination thereof. In some example implementations, the physical function may represent the PCIe function configured to support the SR-IOV function. The SR-IOV may represent a function that allows one physical function to support one or more dependent virtualization functions.

In the method of operating the storage device 300b included in the storage system 100b, when the data read request RREQ is received from one of the plurality of host devices 200a to 200c, the storage device 300b may operate based on the first read scheme or the second read scheme depending on the characteristic (e.g., physical functional characteristic) of the storage controller corresponding to the host device that provides the data read request RREQ.

Referring to FIG. 14B, an example of a storage system 100c that performs the operation of FIG. 13 is illustrated. The descriptions repeated with or overlapping with descriptions of FIG. 14A will be omitted in the interest of brevity.

The storage system 100c may include a plurality of host devices 200a, 200b and 200c and a storage device 300c.

The storage device 300c in FIG. 14B may be substantially the same as the storage device 300b in FIG. 14A, except that the plurality of storage controllers 310a to 310c in FIG. 14B communicate with the plurality of host devices 200a to 200c through a plurality of physical ports PTa, PTb and PTc, respectively.

Referring to FIG. 14C, an example of a read manager 700d that performs the operation of FIG. 13 is illustrated.

The read manager 700d may include an analysis logic circuit 710d, a determination logic circuit 720d and a read scheme control logic circuit 730.

The analysis logic circuit 710d may obtain a fourth parameter PFP by analyzing the data read request RREQ. For example, the fourth parameter PFP may represent a physical function characteristic associated with the data read request RREQ, and may be referred to as a physical function parameter.

The determination logic circuit 720d may generate a determination signal DET that represents the attribute of the data read request RREQ based on the fourth parameter PFP. For example, when it is determined based on the fourth parameter PFP that the physical functional characteristic is the first physical functional characteristic, e.g., when it is determined that the attribute of the data read request RREQ is the first attribute, the determination signal DET may have the first value. For example, when it is determined based on the fourth parameter PFP that the physical functional characteristic is the second physical functional characteristic, e.g., when it is determined that the attribute of the data read request RREQ is the second attribute, the determination signal DET may have the second value. For example, the determination signal DET in FIG. 14C may correspond the result of determination by operations S218, S220 and S230 in FIG. 13.

In some example implementations, the determination logic circuit 720d may include a physical function lookup table PF_LUT that includes a relationship or correspondence between a plurality of physical functions and whether the plurality of physical functions have the first physical function characteristic or the second physical function characteristic.

The read scheme control logic circuit 730 may be substantially the same as that described with reference to FIG. 8.

In some example implementations, operation S200 may be implemented by combining two or more of the examples of FIGS. 7, 9, 11 and 13. In some example implementations, the read manager may be implemented by combining two or more of the examples of FIGS. 8, 10, 12B and 14C.

FIGS. 15 and 16 are block diagrams illustrating an example of a read manager included in a storage device of FIG. 4.

Referring to FIG. 15, a read manager 700e may include an analysis logic circuit 712, a determination logic circuit 722 and a read scheme control logic circuit 730. The read manager 700e may correspond to a combination of all of the examples of FIGS. 8, 10, 12B and 14C. The descriptions repeated with or overlapping with descriptions of FIGS. 8, 10, 12B and 14C will be omitted in the interest of brevity.

The analysis logic circuit 712 may include a first analysis logic circuit 710a, a second analysis logic circuit 710b, a third analysis logic circuit 710c and a fourth analysis logic circuit 710a. The first, second, third and fourth analysis logic circuits 710a, 710b, 710c and 710d may be substantially the same as the analysis logic circuits 710a, 710b, 710c and 710d in FIGS. 8, 10, 12B and 14C, respectively.

The determination logic circuit 722 may include a first determination logic circuit 720a, a second determination logic circuit 720b, a third determination logic circuit 720c, a fourth determination logic circuit 720d and a fifth determination logic circuit 720e. The first, second, third and fourth determination logic circuits 720a, 720b, 720c and 720d may be substantially the same as the determination logic circuits 720a, 720b, 720c and 720d in FIGS. 8, 10, 12B and 14C, respectively.

The fifth determination logic circuit 720e may generate a determination signal DET based on first, second, third and fourth determination signals DET1, DET2, DET3 and DET4 that are provided from the first, second, third and fourth determination logic circuits 720a, 720b, 720c and 720d. In some example implementations, the fifth determination logic circuit 720e may generate the determination signal DET by assigning different weights to the first, second, third and fourth determination signals DET1, DET2, DET3 and DET4. In some example implementations, the fifth determination logic circuit 720e may generate the determination signal DET by applying a majority voting scheme to the first, second, third and fourth determination signals DET1, DET2, DET3 and DET4.

The read scheme control logic circuit 730 may be substantially the same as that described with reference to FIG. 8.

Referring to FIG. 16, a read scheme control logic circuit 732 may include a first logic circuit 734, a second logic circuit 736 and a multiplexer 738.

The first logic circuit 734 may generate the first command set CS1 corresponding to the first read scheme based on the data read request RREQ. The second logic circuit 736 may generate the second command set CS2 corresponding to the second read scheme based on the data read request RREQ. The multiplexer 738 may output the first command set CS1 or the second command set CS2 based on the determination signal DET.

Although example implementations are described based on specific determination criterion, example implementations are not limited thereto, and various other determination criteria may be applied or employed. Although example implementations are described by selecting one of two read schemes, example implementations are not limited thereto, and example implementations may be implemented by selecting one of three or more different read schemes.

FIG. 17 is a block diagram illustrating a data center including a storage device according to example implementations.

Referring to FIG. 17, a data center 3000 may be a facility that collects various types of data and provides various services, and may be referred to as a data storage center. The data center 3000 may be a system for operating search engines and databases and may be a computing system used by companies such as banks or government agencies. The data center 3000 may include application servers 3100 to 3100n and storage servers 3200 to 3200m. The number of the application servers 3100 to 3100n and the number of the storage servers 3200 to 3200m may be variously selected according to example implementations, and the number of the application servers 3100 to 3100n and the number of the storage servers 3200 to 3200m may be different from each other.

The application server 3100 may include at least one processor 3110 and at least one memory 3120, and the storage server 3200 may include at least one processor 3210 and at least one memory 3220. An operation of the storage server 3200 will be described as an example. The processor 3210 may control overall operations of the storage server 3200, and may access the memory 3220 to execute instructions and/or data loaded in the memory 3220. The memory 3220 may include at least one of a double data rate (DDR) synchronous dynamic random access memory (SDRAM), a high bandwidth memory (HBM), a hybrid memory cube (HMC), a dual in-line memory module (DIMM), an Optane DIMM, a nonvolatile DIMM (NVDIMM), etc. The number of the processors 3210 and the number of the memories 3220 included in the storage server 3200 may be variously selected according to example implementations. In some example implementations, the processor 3210 and the memory 3220 may provide a processor-memory pair. In some example implementations, the number of the processors 3210 and the number of the memories 3220 may be different from each other. The processor 3210 may include a single core processor or a multiple core processor. The above description of the storage server 3200 may be similarly applied to the application server 3100. The application server 3100 may include at least one storage device 3150, and the storage server 3200 may include at least one storage device 3250. In some example implementations, the application server 3100 may not include the storage device 3150. The number of the storage devices 3250 included in the storage server 3200 may be variously selected according to example implementations.

The application servers 3100 to 3100n and the storage servers 3200 to 3200m may communicate with each other through a network 3300. The network 3300 may be implemented using a fiber channel (FC) or an Ethernet. The FC may be a medium used for a relatively high speed data transmission, and an optical switch that provides high performance and/or high availability may be used. The storage servers 3200 to 3200m may be provided as file storages, block storages or object storages according to an access scheme of the network 3300.

In some example implementations, the network 3300 may be a storage-only network or a network dedicated to a storage such as a storage area network (SAN). For example, the SAN may be an FC-SAN that uses an FC network and is implemented according to an FC protocol (FCP). For another example, the SAN may be an IP-SAN that uses a transmission control protocol/internet protocol (TCP/IP) network and is implemented according to an iSCSI (a SCSI over TCP/IP or an Internet SCSI) protocol. In other example implementations, the network 3300 may be a general network such as the TCP/IP network. For example, the network 3300 may be implemented according to at least one of protocols such as an FC over Ethernet (FCOE), a network attached storage (NAS), a nonvolatile memory express (NVMe) over Fabrics (NVMe-oF), etc.

Hereinafter, example implementations will be described based on the application server 3100 and the storage server 3200. The description of the application server 3100 may be applied to the other application server 3100n, and the description of the storage server 3200 may be applied to the other storage server 3200m.

The application server 3100 may store data requested to be stored by a user or a client into one of the storage servers 3200 to 3200m through the network 3300. In addition, the application server 3100 may obtain data requested to be read by the user or the client from one of the storage servers 3200 to 3200m through the network 3300. For example, the application server 3100 may be implemented as a web server or a database management system (DBMS).

The application server 3100 may access a memory 3120n or a storage device 3150n included in the other application server 3100n through the network 3300, and/or may access the memories 3220 to 3220m or the storage devices 3250 to 3250m included in the storage servers 3200 to 3200m through the network 3300. Thus, the application server 3100 may perform various operations on data stored in the application servers 3100 to 3100n and/or the storage servers 3200 to 3200m. For example, the application server 3100 may execute a command for moving or copying data between the application servers 3100 to 3100n and/or the storage servers 3200 to 3200m. The data may be transferred from the storage devices 3250 to 3250m of the storage servers 3200 to 3200m to the memories 3120 to 3120n of the application servers 3100 to 3100n directly or through the memories 3220 to 3220m of the storage servers 3200 to 3200m. For example, the data transferred through the network 3300 may be encrypted data for security or privacy.

In the storage server 3200, an interface 3254 of the storage device 3250 may provide a physical connection between the processor 3210 and a controller 3251 of the storage device 3250 and/or a physical connection between a network interface card (NIC) 3240 and the controller 3251. For example, the interface 3254 may be implemented based on a direct attached storage (DAS) scheme in which the storage device 3250 is directly connected with a dedicated cable. For example, the interface 3254 may be implemented based on at least one of various interface schemes such as an advanced technology attachment (ATA), a serial ATA (SATA) an external SATA (e-SATA), a small computer system interface (SCSI), a serial attached SCSI (SAS), a peripheral component interconnection (PCI), a PCI express (PCIe), an NVMe, a compute express link (CXL), an IEEE 1394, a universal serial bus (USB), a secure digital (SD) card interface, a multi-media card (MMC) interface, an embedded MMC (eMMC) interface, a universal flash storage (UFS) interface, an embedded UFS (eUFS) interface, a compact flash (CF) card interface, etc.

The storage server 3200 may further include a switch 3230 and the NIC 3240. The switch 3230 may selectively connect the processor 3210 with the storage device 3250 or may selectively connect the NIC 3240 with the storage device 3250 under a control of the processor 3210. Similarly, the application server 3100 may further include a switch 3130 and an NIC 3140.

In some example implementations, the NIC 3240 may include a network interface card, a network adapter, or the like. The NIC 3240 may be connected to the network 3300 through a wired interface, a wireless interface, a Bluetooth interface, an optical interface, or the like. The NIC 3240 may further include an internal memory, a digital signal processor (DSP), a host bus interface, or the like, and may be connected to the processor 3210 and/or the switch 3230 through the host bus interface. The host bus interface may be implemented as one of the above-described examples of the interface 3254. In some example implementations, the NIC 3240 may be integrated with at least one of the processor 3210, the switch 3230 and the storage device 3250.

In the storage servers 3200 to 3200m and/or the application servers 3100 to 3100n, the processor may transmit a command to the storage devices 3150 to 3150n and 3250 to 3250m or the memories 3120 to 3120n and 3220 to 3220m to program or read data. For example, the data may be error-corrected data by an error correction code (ECC) engine. For example, the data may be processed by a data bus inversion (DBI) or a data masking (DM), and may include a cyclic redundancy code (CRC) information. For example, the data may be encrypted data for security or privacy.

The storage devices 3150 to 3150m and 3250 to 3250m may transmit a control signal and command/address signals to NAND flash memory devices 3252 to 3252m of the storage devices 3250 and 3250m in response to a read command received from the processor. When data is read from the NAND flash memory devices 3252 to 3252m, a read enable (RE) signal may be input as a data output control signal and may serve to output data to a DQ bus. A data strobe signal (DQS) may be generated using the RE signal. The command and address signals may be latched in a page buffer based on a rising edge or a falling edge of a write enable (WE) signal.

The controller 3251 may control overall operations of the storage device 3250. In some example implementations, the controller 3251 may include a static random access memory (SRAM). The controller 3251 may write data into the NAND flash memory device 3252 in response to a write command, or may read data from the NAND flash memory device 3252 in response to a read command. For example, the write command and/or the read command may be provided from the processor 3210 in the storage server 3200, the processor 3210m in the other storage server 3200m, or the processors 3110 to 3110n in the application servers 3100 to 3100n. A DRAM 3253 in the storage device 3250 may temporarily store (e.g., may buffer) data to be written to the NAND flash memory device 3252 or data read from the NAND flash memory device 3252. Further, the DRAM 3253 may store meta data. The meta data may be data generated by the controller 3251 to manage user data or the NAND flash memory device 3252.

Each of the storage devices 3250 to 3250m may be the storage device according to example implementations and may perform the method of operating the storage device according to example implementations.

The example implementations may be applied to various electronic devices and systems that include the storage devices. For example, the example implementations may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, an automotive device, etc.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The foregoing is illustrative of example implementations and is not to be construed as limiting thereof. Although some example implementations have been described, those skilled in the art will readily appreciate that many modifications are possible in the example implementations without materially departing from the novel teachings and advantages of the example implementations. Accordingly, all such modifications are intended to be included within the scope of the example implementations as defined in the claims. Therefore, it is to be understood that the foregoing is illustrative of various example implementations and is not to be construed as limited to the specific example implementations disclosed, and that modifications to the disclosed example implementations, as well as other example implementations, are intended to be included within the scope of the appended claims.

What is claimed is:

1. A method of operating a storage device, the method comprising:
transmitting a first command set corresponding to a first read scheme to a nonvolatile memory based on a data read request having a first attribute, the first command set including a data read command and a first number of status check commands, the data read request being received from a device external to the storage device or internally generated in the storage device, or
transmitting a second command set corresponding to a second read scheme to the nonvolatile memory based on the data read request having a second attribute, the second command set including the data read command and a second number of status check commands, the second read scheme being different from the first read scheme, the second attribute being different from the first attribute, the second number being different from the first number;
receiving read data corresponding to the data read command from the nonvolatile memory,
determining that an attribute of the data read request has changed; and
transmitting the first command set, in place of the second command set, to the nonvolatile memory or transmitting the second command set, in place of the first command set, to the nonvolatile memory, based on determining that the attribute of the data read request has changed.

2. The method of claim 1, wherein:
the first read scheme improves latency performance of a data read operation, and
the second read scheme improves bandwidth performance of the data read operation.

3. The method of claim 2, wherein the second number is less than the first number.

4. The method of claim 3, wherein the first number is two, and the second number is one.

5. The method of claim 1, wherein, in the first read scheme:
the data read command is transmitted to the nonvolatile memory,
during a first time interval after the data read command is transmitted, a first operation in which the read data is retrieved from the nonvolatile memory is performed,
after the first time interval, a first status check command for checking a completion of the first operation is transmitted to the nonvolatile memory,
during a second time interval after the first time interval and after the first status check command is transmitted, a second operation in which the read data is output from the nonvolatile memory and a third operation in which an execution of a next command after the data read command is prepared are performed, and
after the second time interval, a second status check command for checking a completion of the third operation is transmitted to the nonvolatile memory.

6. The method of claim 5, wherein, in the second read scheme:
the data read command is transmitted to the nonvolatile memory,
during a third time interval after the data read command is transmitted, the first operation and the third operation are performed,
after the third time interval, a third status check command for checking a completion of the first operation and the third operation is transmitted to the nonvolatile memory, and
during a fourth time interval after the third time interval and after the third status check command is transmitted, the second operation is performed.

7. The method of claim 1, wherein the attribute of the data read request is determined based on a type of the data read request.

8. The method of claim 7, wherein the data read request is one of an external read request that is received from a host device located outside the storage device, an internal read request that is internally generated in the storage device, a random read request associated with discontinuous logical addresses, or a sequential read request associated with continuous logical addresses.

9. The method of claim 1, wherein the attribute of the data read request is determined based on a queue depth that represents a number of a plurality of data input/output (I/O) requests waiting to be performed in the storage device.

10. The method of claim 9, wherein
when the queue depth is less than a reference value, the data read request has the first attribute, and the first command set corresponding to the first read scheme is transmitted to the nonvolatile memory, or
when the queue depth is greater than or equal to the reference value, the data read request has the second attribute, and the second command set corresponding to the second read scheme is transmitted to the nonvolatile memory.

11. The method of claim 1, wherein:
the data read request is received from a host device located outside the storage device, and
the attribute of the data read request is determined based on a characteristic of the host device.

12. The method of claim 11, wherein:
the storage device is controlled by a plurality of host devices,
a plurality of domains are formed by the plurality of host devices, and
the characteristic of the host device corresponds to characteristics of the plurality of domains.

13. The method of claim 1, wherein:
the storage device includes a plurality of physical functions, and
the attribute of the data read request is determined based on characteristics of the plurality of physical functions.

14. The method of claim 1, further comprising:
determining the attribute of the data read request.

15. The method of claim 14, wherein the attribute of the data read request is determined based on at least one of a type of the data read request, a queue depth of the storage device, a characteristic of a host device that is located outside the storage device and provides the data read request, and characteristics of a plurality of physical functions that are included in the storage device.

16. A storage device comprising:
at least one nonvolatile memory; and
a storage controller configured to control an operation of the nonvolatile memory,
wherein the storage controller is configured to:
transmit a first command set corresponding to a first read scheme to the nonvolatile memory based on a data read request having a first attribute, the first command set including a data read command and a first number of status check commands, the data read request being received from a device external to the storage device or internally generated in the storage device, or
transmit a second command set corresponding to a second read scheme to the nonvolatile memory based on the data read request having a second attribute, the second command set including the data read command and a second number of status check commands, the second read scheme being different from the first read scheme, the second attribute being different from the first attribute, the second number being different from the first number,
receive read data corresponding to the data read command from the nonvolatile memory,
determine that an attribute of the data read request has changed, and
transmit the first command set, in place of the second command set, to the nonvolatile memory or transmit the second command set, in place of the first command set, to the nonvolatile memory, based on determining that that attribute of the data read request has changed.

17. The storage device of claim 16, wherein the storage controller includes:
an analysis logic circuit configured to obtain at least one parameter by analyzing the data read request;
a determination logic circuit configured to generate a determination signal representing the attribute of the data read request based on the parameter; and
a read scheme control logic circuit configured to output the first command set or the second command set based on the determination signal.

18. The storage device of claim 17, wherein the read scheme control logic circuit is configured to generate only one of the first command set and the second command set based on the determination signal.

19. The storage device of claim 17, wherein the read scheme control logic circuit includes:
a first logic circuit configured to generate the first command set corresponding to the first read scheme;
a second logic circuit configured to generate the second command set corresponding to the second read scheme; and
a multiplexer configured to output the first command set corresponding to the first read scheme or the second command set corresponding to the second read scheme based on the determination signal.

20. A method of operating a storage device, the method comprising:
receiving a data read request from a host device located outside the storage device;
determining an attribute of the data read request;
transmitting a first command set corresponding to a first read scheme to a nonvolatile memory based on the data read request having a first attribute, the first command set including a data read command and a first number of status check commands; or
transmitting a second command set corresponding to a second read scheme to the nonvolatile memory based on the data read request having a second attribute, the second command set including the data read command and a second number of status check commands, the second read scheme being different from the first read scheme, the second attribute being different from the first attribute, the second number being less than the first number;
receiving read data from the nonvolatile memory, the read data corresponding to the data read command that is transmitted based on the first read scheme or the second read scheme,
wherein the first read scheme represents a scheme which improves latency performance of a data read operation,
wherein, in the first read scheme:
the data read command is transmitted to the nonvolatile memory,
during a first time interval after the data read command is transmitted, a first operation in which the read data is retrieved from the nonvolatile memory is performed,
after the first time interval, a first status check command for checking a completion of the first operation is transmitted to the nonvolatile memory,
during a second time interval after the first time interval and after the first status check command is transmitted, a second operation in which the read data is output from the nonvolatile memory and a third operation in which an execution of a next command after the data read command is prepared are performed, and
after the second time interval, a second status check command for checking a completion of the third operation is transmitted to the nonvolatile memory,
wherein the second read scheme represents a scheme which improves bandwidth performance of the data read operation, and
wherein, in the second read scheme:
the data read command is transmitted to the nonvolatile memory,
during a third time interval after the data read command is transmitted, the first operation and the third operation are performed,
after the third time interval, a third status check command for checking a completion of the first operation and the third operation is transmitted to the nonvolatile memory, and
during a fourth time interval after the third time interval and after the third status check command is transmitted, the second operation is performed.
